(19) United States
(12) Patent Application Publication
(10) Pub. No.: US 2024/0087006 A1
(43) Pub. Date: Mar. 14, 2024

(54) METHOD AND SYSTEM FOR CONTENT SHARING

(71) Applicant: Contented Media Group Ltd, London (GB)

(72) Inventors: Maarten Ectors, London (GB); Toby Britton, London (GB); Lee Buchanan, London (GB); Andrew Foyle, London (GB)

(21) Appl. No.: 18/463,422

(22) Filed: Sep. 8, 2023

Related U.S. Application Data
(60) Provisional application No. 63/374,969, filed on Sep. 8, 2022.

(51) Int. Cl. G06Q 30/08; G06F 21/10; G06Q 30/018; G06Q 30/0201; H04L 9/00

(52) U.S. Cl. CPC G06Q 30/08; G06F 21/10; G06Q 30/018; G06Q 30/0206; H04L 9/50

(57) ABSTRACT

Disclosed is a method for sharing content on a decentralized platform comprising uploading content items by plurality of content creators; generating ownership non-fungible token (NFT) for each uploaded content item, wherein each generated NFT is owned by its respective content creator; calculating the price of each content item based on number and/or value of bids placed by one or more scouts for corresponding content item; transferring a share of ownership in ownership NFT from respective content owner to one or more scouts winning the bid; and automatically distributing payment received for licensed content item among corresponding NFT owners.

### TECHNICAL FIELD

This invention relates to content sharing. In particular, though not exclusively, this invention relates to a method for sharing content on a decentralized platform and a system for content sharing.

### BACKGROUND

With the advent of digital marketing, digital platforms for content sharing have experienced a major boom. In this regard, product/service providers and marketers from various fields have an interest in such digital platforms. Due to the high proliferation of such platforms, there is a lot of information noise on the internet, making it increasingly difficult for marketers to find appropriate content. This does not allow the marketers to connect with appropriate content creators thereof.

Such issues are experienced in the field of content generation and marketing. Often, marketers are unable to find appropriate content to fit their creative briefs. This requires assistance from content curators (manual or digital), which eventually adds onto the costs, making the content more expensive for marketers. Such content curators are not only cost-intensive for the marketers but also underpay the content creators who do the actual work of creating content. Such content curators act as “middlemen” or “gatekeepers” and govern centralized markets. Moreover, if a content does get licensed by a marketer, calculation and transfer of payments are also often done manually, which can be prone to errors. Additionally, the popularity of a content item cannot be predicted and/or guaranteed, and the content marketer is unable to request original content which has a high chance of being viral.

Therefore, in light of the foregoing discussion, there exists a need to overcome the aforementioned drawbacks associated with marketing content controlled by content curators.

### SUMMARY OF THE INVENTION

In a first aspect, the present disclosure provides a method for sharing content on a decentralized platform, the method comprising:
uploading content items by a plurality of content creators; generating an ownership non-fungible token (NFT) for each uploaded content item, wherein each generated NFT is owned by its respective content creator;
calculating a price of each content item based at least on a number and/or value of bids placed by one or more scouts for the corresponding content item;
transferring a share of ownership in an ownership NFT from a respective content owner to the one or more scouts winning the bid; and automatically distributing a payment received for a licensed content item among the corresponding NFT owners.

In a second aspect, the present disclosure provides a system for content sharing comprising:
an input-output interface;
a database; and
a processing; wherein the processing further comprises:
   a content creator module configured to upload content items on the database by a plurality of content creators;
   a token generator module configured to generate an ownership non-fungible token (NFT) for each uploaded content item, wherein each generated NFT is owned by its respective content creator;
   a pricing module configured to calculate a price of each content item based at least on a number and/or value of bids placed by one or more scouts for the corresponding content item;
   an ownership module configured to transfer a share of ownership in an ownership NFT from a respective content owner to the one or more scouts winning the bid; and
   a payment module configured to automatically distribute a payment received for a licensed content item among the corresponding NFT owners.

In a third aspect, the present disclosure provides a computer-readable medium comprising instructions which, when executed by a computer, cause the computer to carry out the steps of the method for sharing content on a decentralized platform.

### DETAILED DESCRIPTION

In a first aspect, an embodiment of the present disclosure provides a method for sharing content on a decentralized platform, the method comprising:
uploading content items by a plurality of content creators; generating an ownership non-fungible token (NFT) for each uploaded content item, wherein each generated NFT is owned by its respective content creator;
calculating a price of each content item based at least on a number and/or value of bids placed by one or more scouts for the corresponding content item;
transferring a share of ownership in an ownership NFT from a respective content owner to the one or more scouts winning the bid; and automatically distributing a payment received for a licensed content item among the corresponding NFT owners.

Throughout the present disclosure, the term “decentralized platform” refers to a platform which facilitates data communication between digital nodes. The decentralized platform is not centralized, which means that it is not governed by a single entity, and therefore does not require any intermediaries for sharing content therewith. Moreover, the decentralized platform provides various tools, security protocols, rules and such like for the execution of tasks including, but not limited to, communication, processing of information and so forth, between different users associated with the decentralized platform. It will be appreciated that the decentralized platform may be representative of a real-world environment, such as a real-world market, wherein one or more services/products are provided and/or procured. The decentralized platform is beneficially adaptive in its hardware operation in response to a type of task being processed therethrough. A technical advantage of using the decentralized platform is that it eliminates (prior) reliability on intermediaries.

Optionally, the decentralized platform is based on blockchain technology. The blockchain technology refers to building a digital ledger of information, as a structure which stores records (as blocks), in a network connected via nodes (as chain). It will be appreciated that data of a blockchain is stored chronologically, such that each new record (i.e., block) is linked to a previous record and a next record (i.e., chain). Moreover, the blockchain is stored publicly, in multiple databases and devices, such that it may never be hacked, altered or deleted. Since the blocks of the blockchain are stored at multiple places, it is nearly impossible to hack into, alter or delete blockchain records. Optionally, the information is encrypted using cryptography. A technical advantage of using blockchain technology is to ensure that the privacy of users is not compromised, and data cannot be altered.

Throughout the present disclosure, the term “content creator” refers to an entity which creates content. Herein, the entity may be a human, a computer, a robot, and so forth. The plurality of content creators upload the content items using a user device. Examples of the user device include, but are not limited to, a computer, a laptop, a mobile phone, a tablet, a phablet, or a smart wearable device. Throughout the present disclosure, the term “content item” refers to a piece of information that engages a target audience to increase the marketability of a business. The content item may be implemented as an image, an infographic, a video, an article, and so forth. It will be appreciated that the plurality of content creators upload the content items on the decentralized platform. Moreover, the plurality of content creators upload the content items on the decentralized platform, such that it may be accessible to a given content marketer.

Optionally, the content is uploaded by the content creators in response to a creative brief received from a content marketer. The term “creative brief” refers to information and/or instructions pertaining to a marketing campaign. It will be appreciated that the creative brief acts as a guideline for the plurality of content creators to create, and thereby, upload the content items. Moreover, the creative brief is also considered as a request on the decentralized platform, for the creation of the content items which fit the creative brief. In a first example, the content marketer may ask for viral content in the creative brief.

Throughout the present disclosure, the term “non-fungible token (NFT)” refers to a record on the decentralized platform which is associated with a given asset. Optionally, the given asset is implemented as: a physical asset, or a digital asset. An ownership of a given NFT is recorded in the decentralized platform along with date and time information, such that changes in ownership of the given NFT over time are accessible. Herein, the ownership NFT represents ownership of a given content creator over a given content item. In operation, the ownership NFT reflects a percentage of future licensing ownership (which may fall between 1%-100%) for each content owner. Moreover, the ownership of the NFT may link to the given content item. The given content item is owned by the given content creator because the given content item is the intellectual property of the content creator. The content marketer may, thereby, either license or buy the given content item from the given content creator for usage. Moreover, since the ownership NFT represents ownership of the given content item, the ownership NFT is also owned by the given content creator.

Optionally, a marketing NFT is generated for the creative brief received from the content marketer. The marketing NFT represents the marketing campaign for which the content marketer wishes to receive submissions. It will be appreciated that the marketing NFT links to instructions and/or directives in congruence with the creative brief. Beneficially, the marketing NFT is representative of information pertaining to the request on the decentralized platform, wherein the information pertaining to the request comprises the request, the date and time of the request, a turn around time for the request, and so forth. Moreover, the creative brief is stored in an Interplanetary File System (IPFS)-based storage. Herein, each change in the creative brief is treated as an amendment and accordingly noted at the decentralized platform, and therefore cannot be edited and/or removed. This, in operation, ensures that the content marketer does not request revisions that change the scope of the content item from the creative brief. Beneficially, utilizing the IPFS-based storage for the creative brief is cost-effective as compared to storing the creative brief using NFTs.

The term “price” refers to a monetary amount associated with a value of the given content item. It will be appreciated that the price for the given content item is decided based also on at least one of: creativity displayed by the given content creator, accuracy with respect to the creative brief, preference of the content marketer, and popularity in public. Herein, the popularity in public is represented by the number and/or value of bids placed by one or more scouts on the given content item. The bids reflect an offer of a price for the content item, made by one or more scouts to license and/or sell the given content item. Beneficially, a high number of bids and/or a high value of bids represent the popularity of the given content item, thereby increasing the price of the content item. In an example, if a first content item has received three bids for $3, $7, and $10 and if a second content item has received a single bid for $1, the price of the first content item may be more than a price of the second content item. Optionally, the price of a given content item is selected as at least one of: $1, 3*(total bidding value). It will be appreciated that a higher price of the above-mentioned options is selected as the price of the given content item. In an example, if the total bidding value is $0.3, then the price for the given content item may be selected as $1 since that is higher than $0.9 (3*0.3). In another example, if the total bidding value is $5, then the price for the given content item may be selected as $15, since $15 (3*5) is higher than $1.

Optionally, a minimum bidding price is calculated based on the number and/or value of bids placed by one or more scouts for the corresponding content item. Herein, the minimum bidding price is a price for each content item, from which a bidding may be initiated by one or more scouts. In an example, the minimum bidding price for the given content item may be set as $0.5. Optionally, the price of the given content item is also based on a classification of the given content item. The classification may be selected as at least one of: standard or premium. Herein, the given content item may be classified as standard if no scout bids on it for a predefined number of days. In accordance with the above example, if the given content item is not bid on for 5 days, the given content item may be classified as ‘standard content’. It will be appreciated that the content marketer may explicitly search for and find such standard content on the decentralized platform. Moreover, the given content item may be classified as premium if it gets licensed. In accordance with the above example, if the standard content gets licensed, its price is calculated to be $1, and it is classified as ‘premium content’. Furthermore, the given content item may be classified as premium if it gets bid on. In accordance with the above example, if the standard content (or non-classified content) is bid-on by one or more scouts, its price is calculated as $1.5 (since 3*0.5=$1.5 I greater than $1), and it is classified as ‘premium content’.

Optionally, the price of each content item is calculated based also on a pricing model, wherein the pricing model is implemented as at least one of: pay-per-interaction (paid on a monthly basis), a standard payment per channel, and payment for ownership. It will be appreciated that the given content item is being licensed in the pay-per-interaction, and the standard payment-per-channel pricing models. In the pay-per-interaction pricing model, the price is determined based on an interaction of the public with the given content item. Herein, interaction pertains to likes, views, shares, comments, and so forth. For example, the price may be high if the number of likes, and comments are high. In the standard payment per channel pricing model, the price is determined based on the number of channels on which the given content item is to be used, and which channels would the given content item be used for. Herein, a high price may be calculated for popular channels or for a greater number of channels. For example, the price may be calculated as $100 for licensing the given content item for the social-media channel Twitter®. In the payment for ownership pricing model, the price is determined based on the value of the given content item. Herein, since ownership of the given content item is being changed, the price is set such that it covers the costs of the given content creator and is not too expensive for the content marketer. For example, the given content item may be priced at $1000. It will be appreciated that the price for the given content item may also be decided based on additional criterion with respect to the creative brief, the given content item, and so forth.

Optionally, the method further comprises generating a license NFT for recording licensing of the content item by the content marketer at a predetermined price. Herein, the license NFT reflects the licensing of the given content item. The license NFT is generated by the platform and comprises the predetermined price for licensing. Beneficially, when the given content item is licensed, the predetermined price represented in the license NFT is automatically distributed to holders of the ownership NFTs of the given content item. It will be appreciated that the predetermined price for licensing the content item depends on the price of the content item. Beneficially, the license NFT enable the decentralized platform to function autonomously (i.e., without needing to hire any manual content curators), which results in both the content marketers to get better and cheaper content, and the content creators to earn more.

The term “scout” refers to a person who searches for creative and marketable content items on the decentralized platform. One or more scouts bid on the content items to show interest in a given content item, wherein the bid also comprises an offer of payment that a given scout is willing to make for the given content item. In operation, the role of a scout is to assist in determining which content items have high chances of being popular. By bidding, one or more scouts determine which content items have a high chance of being licensed and/or being highly popular. A scout bidding the highest amount for the given content item may win the bid. The scout who wins the bid for the given content item pays the bid amount to the given content creator, and a part of the ownership of the given content item is transferred to the scout. Herein, the scout receives a part of the ownership NFT from the given content creator and/or content owner. It will be appreciated that the share in ownership in the ownership NFT is transferred from the respective content owner to one or more scouts winning the bid in exchange for payment of the respective bidding value.

Optionally, the method further comprises calculating a reputation score for one or more scouts based on a record of their past earnings and spent by placing bids on the content items. The term “reputation score” refers to a metric which represents a probability of success of a given scout in predicting content trends. Herein, a scout is deemed to have a high reputation score when the record of their past earnings and spending demonstrates that they have earned more than they spent on placing bids on the content items. It will be appreciated that scouts who have bid on content items which have a high price (representative of high bids and/or high values of bids), may also have the high reputation score, and vice versa. Beneficially, the reputation score assists the content marketer in finding favorable content items, since content items bid on by scouts having high reputation scores are likely to go viral.

Optionally, a scout with a higher reputation score has a higher probability of winning a bid for a content item. It will be appreciated that the scout having the highest bid may not win the bid for the content item. Moreover, winning of a bid by a scout is based at least on: a bid time, a bid value, and the reputation score of the scout. The scout having a higher reputation score as compared to another scout may have more popularity with the content marketer(s), and bidding by such scouts may increase the marketability of the content item. Such an increase in the marketability may ultimately increase interaction by the public with the content item, which eventually increases the price of the content item. Thereby, beneficially, a high reputation score may be an important factor in determining which scout wins a bid for the content item.

Optionally, each of the one or more scouts has a share in an ownership NFT in the range of 1% to 100% for a content item. It will be appreciated that each of the one or more scouts who have won a bid for the content item have a share in the ownership NFT of the content item. When the given content creator submits the given content item towards the creative brief, the given content creator owns an entirety of the content (i.e., 100%) via the ownership NFT. Moreover, when one or more scouts bid on the given content item, they buy away percentages of ownership of the content item and respective amounts of the ownership NFT get transferred from the given content creator to the highest bidding scout. Since one or more scouts have the share of a whole content item, the share in the ownership lies in the range of 1% to 100%. For example, the share in the ownership NFT of a given scout may be from 1%, 2%, 4%, 8%, 12%, 18%, 25%, 35%, 50%, 65%, 75%, 82%, 88%, 92% or 94% up to 2%, 4%, 8%, 12%, 18%, 25%, 35%, 50%, 65%, 75%, 82%, 88%, 92%, 96%, 98% or 100%. Beneficially, each of the one or more scouts bidding on and thereby investing in the content item avail profits based on their share in the content item. Optionally, one or more scouts collectively have a share in an ownership NFT in the range of 1% to 20% for a content item. Alternatively, optionally, the share in an ownership NFT for a content item available to one or more scouts is decided by the given content creator of the content item.

Once one or more scouts win a bid for the content item, they become part owners of the ownership NFT. Herein, the payment received for the licensed content item from the content marketer is divided between the content owners based on their share of ownership of the content item. Optionally, the content owner is at least one of: a content creator, a scout, a general user of the decentralized platform. For example, if the content creator owns 50% of the content item, and a scout owns the remaining 50% and the content item gets licensed for $1000, the content owner and the scout each get $500. Optionally, a license for the content item may be provided for: a one-time payment model, or a pay-per-view payment model. Herein, the content marketer may pay for the content item based on the popularity of the content item (i.e., the number of views/interactions with the content item). In accordance with the first example, the content marketer may pay-per-view for the content item, so if the content item does not go viral, the content marketer may not have to pay much. Optionally, the ownership of NFT is managed using smart contracts.

Optionally, the content item with the highest number or highest value of bids is first presented to the content marketer. Generally, the content item having the highest number or highest value of bids is considered popular. In operation, popular content items are presented to the content marketer first on the decentralized platform. Beneficially, this ensures that the content marketer does not have to spend a vast amount of time searching for popular content items and instead may timely find a relevant content item. Moreover, by showing the content items that the scouts think will be popular first, the content marketer can avoid having to go through thousands of submissions and can focus on a handful of popular content. It will be appreciated that the content marketer sees the best content submissions based on high biddings by one or more scouts having high reputation scores. Moreover, it will be appreciated that a focus of the present disclosure is directed towards content discovery, content pricing and content licensing.

In a second aspect, an embodiment of the present disclosure provides a system for content sharing comprising:
an input-output interface;
a database; and
a processing; wherein the processing further comprises:
   a content creator module configured to upload content items on the database by a plurality of content creators;
   a token generator module configured to generate an ownership non-fungible token (NFT) for each uploaded content item, wherein each generated NFT is owned by its respective content creator;
   a pricing module configured to calculate a price of each content item based at least on a number and/or value of bids placed by one or more scouts for the corresponding content item;
   an ownership module configured to transfer a share of ownership in an ownership NFT from a respective content owner to the one or more scouts winning the bid; and
   a payment module configured to automatically distribute a payment received for a licensed content item among the corresponding NFT owners.

It will be appreciated that the system facilitates content sharing. The system comprises specialized equipment configured to perform specialized tasks for effectively sharing content, including the input-output interface, the database and the processing. The term “input-output interface” refers to an interface via which users can interact with the system. Optionally, the input-output interface is displayed on the user device. The term “database” refers to a memory, in which data or software can be stored for any duration. A given memory may be local memory that is integrated with the processing, may be an external memory, may be a cloud-based memory, or similar. It will be appreciated that the database stores data pertaining to the system for content sharing. Optionally, the database further comprises a blockchain-based storage, an InterPlanetary File System (IPFS)-based storage.

Throughout the present disclosure, the term “processing” refers to hardware, software, firmware, or a combination of these configured to control the operation of the system. In this regard, the processing performs several complex processing tasks. The processing is communicably coupled to other components of the system wirelessly and/or in a wired manner. In an example, the processing may be implemented as a programmable digital signal processor (DSP). In another example, the processing may be implemented via a cloud server that provides a cloud computing service. Optionally, the processing utilizes at least one of: smart contracts, serverless cloud functions, for performing the processing tasks of the system.

The content creator module is a tool in the user device which accesses the input-output interface for uploading the content items onto the database. The token generator module generates the ownership NFT for the given content item, which represents ownership of the given content item. The pricing module calculates a base price for the content item based on the number and/or value of bids placed by one or more scouts for the corresponding content item. Herein, a bidding price itself is not calculated, however, a minimum bidding price is set such that one or more scouts may initiate bidding from the minimum bidding price. The ownership module transfers ownership between content owners, such that the share of ownership in any content item is updated. The payment module distributes the payments amongst the content owners, based on their respective shares in the content item. Optionally, the payment module automatically distributes the payments amongst the content owners by utilizing contended tokens (COTOs). It will be appreciated that the pricing module, the token generator module, the ownership module, and the payment module are dynamic modules which change with each change experienced in the system. For example, if a scout bids a large amount on a content item, the pricing module dynamically increases the price of the content item.

Optionally, the system is a blockchain-enabled e-commerce platform. It will be appreciated that the system is blockchain-enabled, which means that the system functions on a decentralized platform, which is not governed by any single entity. Moreover, the system is an e-commerce platform, which means that the system enables economic commercial transactions. In operation, the content items are presented on the e-commerce platform, wherein the content marketer may choose a content item and pay electronically for licensing the same. Beneficially, this enables content creators, scouts, and content marketers from around the world to communicate, create and share content and earn altogether.

In a third aspect, an embodiment of the present disclosure provides a computer-readable medium comprising instructions which, when executed by a computer, cause the computer to carry out the steps of the method for sharing content on a decentralized platform. In an embodiment, the non-transitory machine-readable data storage medium can direct a machine (such as a computer, other programmable data processing apparatus, or other devices) to function in a particular manner, such that the program instructions stored in the non-transitory machine-readable data storage medium case a series of steps to implement the function specified in a flowchart corresponding to the instructions. Examples of non-transitory machine-readable data storage medium includes, but is not limited to, an electronic storage device, a magnetic storage device, an optical storage device, an electromagnetic storage device, a semiconductor storage device, a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, or any suitable combination thereof.

Throughout the description and claims of this specification, the words “comprise” and “contain” and variations of the words, for example, “comprising” and “comprises”, mean “including but not limited to”, and do not exclude other components, integers or steps. Moreover, the singular encompasses the plural unless the context otherwise requires: in particular, where the indefinite article is used, the specification is to be understood as contemplating plurality as well as singularity, unless the context requires otherwise.

Preferred features of each aspect of the invention may be as described in connection with any of the other aspects. Within the scope of this application, it is expressly intended that the various aspects, embodiments, examples, and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible.

### BRIEF DESCRIPTION OF THE DRAWINGS

One or more embodiments of the invention will now be described, by way of example only, with reference to the following diagrams wherein:

FIG. 1 is a process flow depicting the steps of a method for sharing content on a decentralized platform, in accordance with an embodiment of the present disclosure;

FIG. 2 is a block diagram representing a system for content sharing, in accordance with an embodiment of the present disclosure; and

FIG. 3 is an exemplary process flow depicting steps of a method for sharing content on a decentralized platform, in accordance with another embodiment of the present disclosure.

### DETAILED DESCRIPTION OF THE DRAWINGS

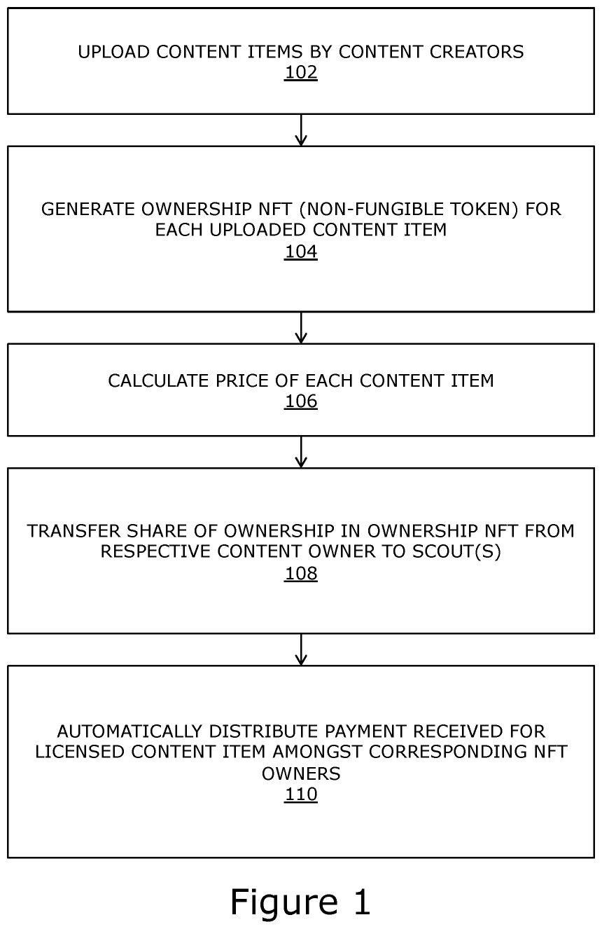

Referring to FIG. 1, a process flow is illustrated depicting the steps of a method for sharing content on a decentralized platform, in accordance with an embodiment of the present disclosure. At step 102, content items are uploaded by a plurality of content creators. At step 104, an ownership non-fungible token (NFT) is generated for each uploaded content item, wherein each generated NFT is owned by its respective content creator. At step 106, the price of each content item is calculated based at least on a number and/or value of bids placed by one or more scouts for the corresponding content item. At step 108, a share of ownership in an ownership NFT is transferred from a respective content owner to one or more scouts winning the bid. At step 110, a payment received for a licensed content item is automatically distributed among the corresponding NFT owners.

The aforementioned steps are only illustrative and other alternatives can also be provided where one or more steps are added, one or more steps are removed, or one or more steps are provided in a different sequence without departing from the scope of the claims herein.

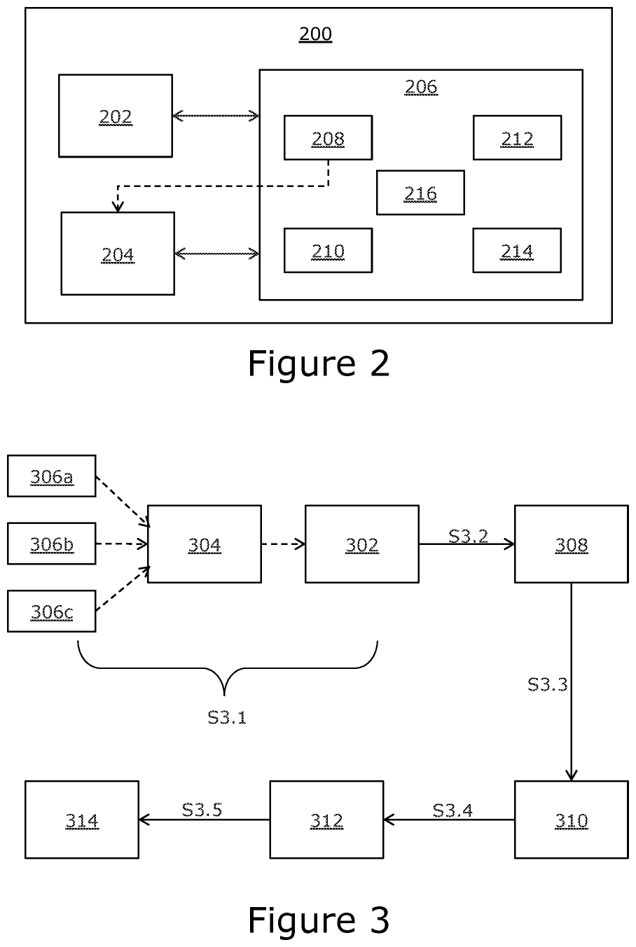

Referring to FIG. 2, illustrated is a block diagram representing a system 200 for content sharing, in accordance with an embodiment of the present disclosure. The system 200 comprises an input-output interface 202, a database 204, and a processing 206. The input-output interface 202 and the database 204 are communicably coupled to the processing 206. The processing 206 comprises a content creator module 208, a token generator module 210, a pricing module 212, an ownership module 214, and a payment module 216. The content creator module 208 is utilized for uploading content items on the database 204 by a plurality of content creators. The token generator module 210 is utilized for generating an ownership non-fungible token (NFT) for each uploaded content item, wherein each generated NFT is owned by its respective content creator. The pricing module 212 is utilized for calculating a price of each content item based at least on a number and/or value of bids placed by one or more scouts for the corresponding content item. The ownership module 214 is utilized for transferring a share of ownership in an ownership NFT from a respective content owner to the one or more scouts winning the bid. The payment module 216 is utilized for automatically distributing a payment received for a licensed content item among the corresponding NFT owners.

Referring to FIG. 3, illustrated is an exemplary process flow depicting steps of a method for sharing content on a decentralized platform, in accordance with an embodiment of the present disclosure. At step S3.1, content items are uploaded on a database 302 using an input-output interface 304 by a plurality of content creators 306a, 306b, and 306c (hereinafter collectively referred to as 306). At step S3.2, an ownership non-fungible token (NFT) is generated for each uploaded content item using a token generator module 308, wherein each generated NFT is owned by its respective content creator 306. At step S3.3, a price of each content item is calculated based on a number and/or value of bids placed by one or more scouts for the corresponding content item, using a pricing module 310. At step S3.4, a share of ownership in an ownership NFT is transferred from a respective content owner to the one or more scouts winning the bid using an ownership module 312. At step S3.5, a payment received for a licensed content item is automatically distributed among the corresponding NFT owners using a payment module 314.

The aforementioned steps are only illustrative and other alternatives can also be provided where one or more steps are added, one or more steps are removed, or one or more steps are provided in a different sequence without departing from the scope of the claims herein.

What is claimed is:

1. A method for sharing content on a decentralized platform, the method comprising the steps of:
i) uploading content items by a plurality of content creators; generating an ownership non-fungible token (NFT) for each uploaded content item, wherein each generated NFT is owned by its respective content creator;
ii) calculating a price of each content item based at least on a number and/or value of bids placed by the one or more scouts for the corresponding content item;
iii) transferring a share of ownership in an ownership NFT from a respective content owner to the one or more scouts winning the bid; and
iv) automatically distributing a payment received for a licensed content item among the corresponding NFT owners.

2. The method of claim 1, wherein in the step of uploading content items, the content is uploaded by the content creators in response to a creative brief received from a content marketer.

3. The method of claim 2, wherein a marketing NFT is generated for the creative brief received from the content marketer.

4. The method of claim 2, further comprising the step of generating a license NFT for recording licensing of the content item by the content marketer at a predetermined price.

5. The method of claim 4, further comprising the step of calculating a reputation score for one or more scouts based on a record of their past earnings and spent by placing bids on the content items.

6. The method of claim 5, wherein a scout with a higher reputation score has higher probability of winning a bid for a content item.

7. The method of claim 6, wherein each of the one or more scouts has a share in an ownership NFT in the range of 1% to 100% for a content item.

8. The method of claim 2, wherein the content item with highest number or highest value of bids is first presented to the content marketer.

9. A system for content sharing comprising:
an input-output interface;
a database; and
a processing; wherein the processing further comprises:
a content creator module configured to upload content items on the database by a plurality of content creators;
a token generator module configured to generate an ownership non-fungible token (NFT) for each uploaded content item, wherein each generated NFT is owned by its respective content creator;
a pricing module configured to calculate a price of each content item based at least on a number and/or value of bids placed by one or more scouts for the corresponding content item;
an ownership module configured to transfer a share of ownership in an ownership NFT from a respective content owner to the one or more scouts winning the bid; and
a payment module configured to automatically distribute a payment received for a licensed content item among the corresponding NFT owners.

10. The system of claim 9 is a blockchain-enabled e-commerce platform.

11. A computer-readable medium comprising instructions which, when executed by a computer, cause the computer to carry out the steps of the method of claim 1.
